(19) United States
(12) Patent Application Publication
(10) Pub. No.: US 2010/0117278 A1
(43) Pub. Date: May 13, 2010

(54) Vacuum sucker for workpiece having through holes

(76) Inventors: Yu-Chen Chang, Taichung (TW); Chih-Hsien Chao, Taichung (TW)

Correspondence Address: Dr. BANGER SHIA;Patent Office of Bang Shia, 102 Lindencrest Ct., Sugar Land, TX, 77479-5201, US

(21) Appl. No.: 12/268,984

(22) Filed: Nov. 11, 2008

(51) Int. Cl. B25B 11/00

(52) U.S. Cl. 269/21

(57) ABSTRACT

A vacuum sucker for workpiece having through holes comprises a vacuum cup and a vacuum accessory. The vacuum cup is provided with a combining section and a vacuum chamber. The vacuum accessory is provided with an assembling section and a suction head having an abutting surface. The vacuum accessory is defined with a passage, the assembling section of the vacuum accessory is screwed with the combining section of the vacuum cup, so that the suction head of the vacuum accessory is located in the vacuum chamber of the vacuum cup. Thereby, the abutting surface of the vacuum accessory can seal the through holes of the workpiece so as to prevent air from outside from entering the vacuum sucker, and the passage of the vacuum accessory is used to vacuum the vacuum chamber of the vacuum cup, thus sucking the workpiece successfully.

### BACKGROUND OF THE INVENTION

1. Field of the Invention

The present invention relates to a vacuum sucker, and more particularly to a vacuum sucker for workpiece having through holes.

2. Description of the Prior Art

With the rapid development of science and technology industry, automatic equipments which is applied to simulate human activities have been improved continually, such as, the application of mechanical arms for simulating human arms. However, due to different using states of the workpieces, the automatic equipments are divided into two types, that is, non-contact type and contact type. As far as the strict environment for processing control tubes is concerned, the non-contact type automatic equipments can prevent the equipments from contacting the workpieces directly, therefore, a vacuum sucker appeared in the market.

Referring to FIG. 1, a conventional vacuum sucker 10 comprises a vacuum cup 11 having a suction portion 111 and a vacuum accessory 12 having a suction passage 121. The vacuum accessory 12 is inserted in the vacuum cup 11, the suction passage 121 of the vacuum accessory 12 is in communication with the suction portion 111 of the vacuum cup 11, and the suction passage 121 of the vacuum accessory 12 is connected to a vacuum generator which is used to vacuum the suction portion 111 of the vacuum cup 11, so as to make the suction portion 111 of the vacuum cup 11 form a negative pressure state, so that the vacuum sucker 10 can suck the workpiece. When the vacuum sucker 10 sucks the workpiece having through holes as shown in FIG. 2, although the vacuum sucker 10 continually produces negative pressure suction to the workpiece, the positive pressure air from outside can also continually enter the through holes of the workpiece, such that the vacuum sucker 10 cannot suck the workpiece successfully. As a result, it will not only affect the manufacturing speed, but also waste the manpower and costs.

The present invention has arisen to mitigate and/or obviate the afore-described disadvantages.

### SUMMARY OF THE INVENTION

The primary objective of the present invention is to provide a vacuum sucker for workpiece having through holes which can suck the workpiece successfully by preventing air from outside from entering the vacuum sucker.

To achieve the objective of the present invention, the vacuum sucker for workpiece having through holes comprises a vacuum cup and a vacuum accessory. One end of the vacuum cup is formed with a combining section, and the other end of the vacuum cup is formed with a vacuum chamber. One end of the vacuum accessory is formed with an assembling section, and the other end of the vacuum accessory is provided with a suction head having an abutting surface. The vacuum accessory is axially defined with a first passage which penetrates from the assembling section to the suction head. The assembling section of the vacuum accessory is screwed with the combining section of the vacuum cup, so that the suction head of the vacuum accessory is located in the vacuum chamber of the vacuum cup.

It is apparent from the above-mentioned descriptions that the present invention has the advantages described as follows: the vacuum sucker utilizes the suction head of the vacuum accessory to seal through holes of the workpiece so as to prevent air from outside from entering the vacuum sucker, and the passage of the vacuum accessory to cooperate with the vacuum chamber to produce vacuum suction to the workpiece, so as to suck the workpiece by the vacuum sucker successfully. Thereby, it can not only quicken the manufacturing speed, but also can save manpower and costs.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a conventional vacuum sucker;

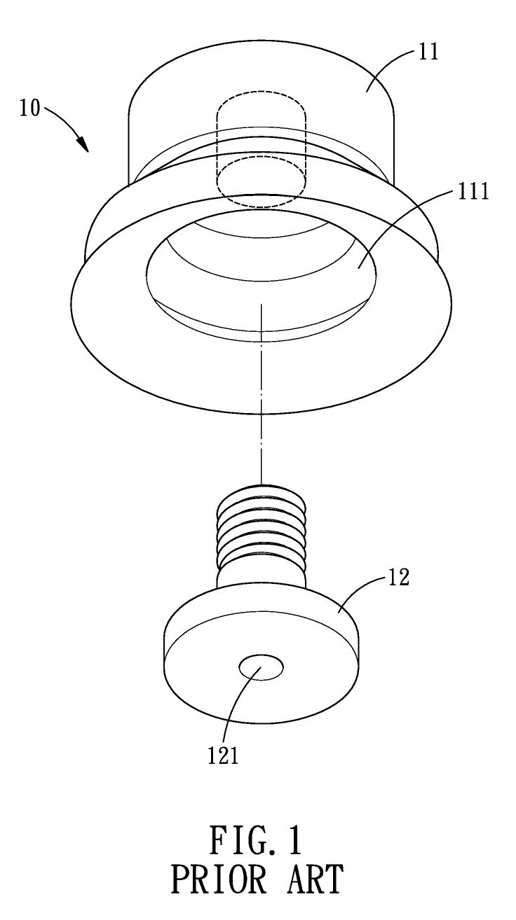

FIG. 2 is an illustrative showing an operation of the conventional vacuum sucker;

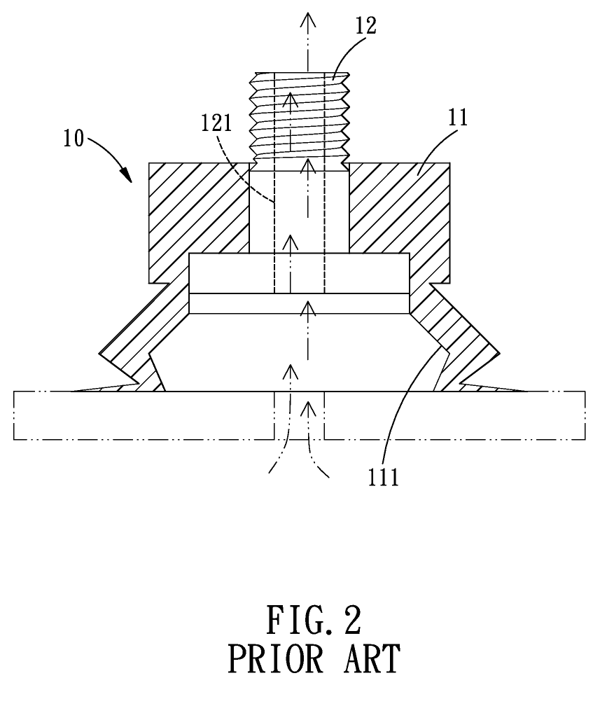

FIG. 3 is an exploded view of a vacuum sucker for workpiece having through holes in accordance with the present invention;

FIG. 4 is an assembly perspective view of the vacuum sucker for workpiece having through holes in accordance with the present invention; and

FIG. 5 is an illustrative showing an operation of the vacuum sucker for workpiece having through holes in accordance with the present invention.

### DETAILED DESCRIPTION OF THE PREFERRED EMBODIMENTS

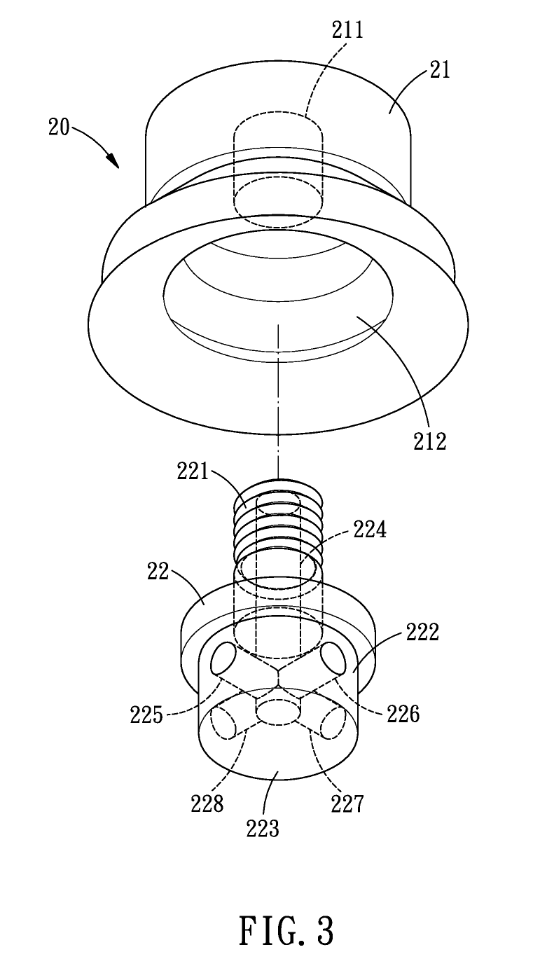

Referring to FIG. 3, a vacuum sucker 20 for workpiece having through holes in accordance with the present invention comprises a vacuum cup 21 and a vacuum accessory 22.

The vacuum cup 21 is flexible, one end of the vacuum cup 21 is axially formed with a cylindrical combining section 211, and the other end of the vacuum cup 21 is axially formed with a cylindrical vacuum chamber 212. The combining section 211 is in communication with the vacuum chamber 212 and is screwed with the vacuum accessory 22.

On an outer surface of one end of the vacuum accessory 22 is axially formed a column-shaped assembling section 221 having outer threads to be screwed with the combining section 211 of the vacuum cup 21, and the other end of the vacuum accessory 22 is axially provided with a column-shaped suction head 222. One end of the suction head 222 is provided with an abutting surface 223. The cross section of the suction head 222 of the vacuum accessory 22 is smaller than that of the vacuum chamber 212 of the vacuum cup 21. The vacuum accessory 22 is axially defined with a first passage 224 which penetrates from the assembling section 221 to the suction head 222. One end of the first passage 224 towards the assembling section 221 is an open end, and the other end of the first passage 224 towards the suction head 222 is a close end. In the outer surface of the suction head 222 of the vacuum accessory 22 are radially defined a second passage 225, a third passage 226, a fourth passage 227 and a fifth passage 228, respectively, which extends towards the close end of the first passage 224. The first passage 224 is in communication with the second, third, fourth and fifth passages 225, 226, 227 and 228 for airflow circulation, respectively, and these passages, 225, 226, 227 and 228 are radially arranged.

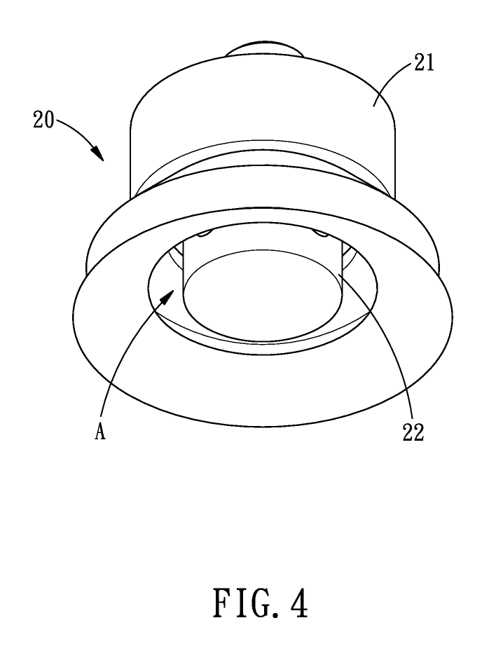

Referring to FIGS. 3 and 4, the assembling section 221 of the vacuum accessory 22 is screwed with the combining section 211 of the vacuum cup 21, so that the suction head 222 of the vacuum accessory 22 is located in the vacuum chamber 212 of the vacuum cup 21, thus forming an airflow distance A between the outer wall of the suction head 222 of the vacuum accessory 22 and the vacuum chamber 212 of the vacuum cup 21.

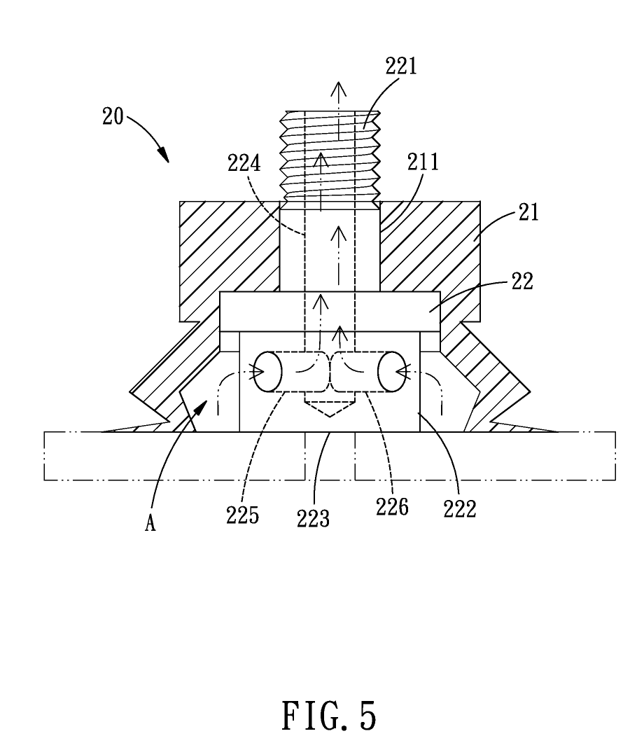

The open end of the first passage 224 of the vacuum accessory 22 is connected to a vacuum generator which is used to vacuum the vacuum chamber 212 of the vacuum cup 21 via the first, second, third, fourth and fifth passages 224, 225, 226, 227 and 228, so as to make the vacuum chamber 212 of the vacuum cup 21 form a negative pressure state, so that the vacuum sucker 20 can suck the workpiece. When the vacuum sucker 20 sucks the workpiece having through holes as shown in FIG. 5, it will seal the through holes of the workpiece with the abutting surface 223 of the suction head 222, so as to prevent the positive pressure air from outside from entering the vacuum chamber 212 of the vacuum cup 21 continuously, thus sucking the workpiece by the vacuum cup 21 successfully.

While we have shown and described various embodiments in accordance with the present invention, it should be clear to those skilled in the art that further embodiments may be made without departing from the scope of the present invention.

What is claimed is:

1. A vacuum sucker for workpiece having through holes comprising:
a vacuum cup, one end of the vacuum cup being provided with a combining section, the other end of the vacuum cup being provided with a vacuum chamber in communication with the combining section; and
a vacuum accessory, one end of the vacuum accessory being provided with an assembling section, the other end of the vacuum accessory being provided with a suction head having an abutting surface at a bottom of one end thereof, in the vacuum accessory being defined a passage which penetrates from the assembling section of the vacuum accessory to an outer surface of the suction head, the assembling section of the vacuum accessory being screwed with the combining section of the vacuum cup, so that the suction head of the vacuum accessory is located in the vacuum chamber of the vacuum cup.

2. The vacuum sucker for workpiece having through holes as claimed in claim 1, wherein the combining section and the vacuum chamber of the vacuum cup are cylindrical.

3. The vacuum sucker for workpiece having through holes as claimed in claim 1, wherein the assembling section and the suction head of the vacuum accessory are column-shaped.

4. The vacuum sucker for workpiece having through holes as claimed in claim 1, wherein the assembling section of the vacuum accessory is defined with outer threads to be screwed with the combining section of the vacuum cup, so that the suction head of the vacuum accessory is located in the vacuum chamber of the vacuum cup.

5. The vacuum sucker for workpiece having through holes as claimed in claim 1, wherein a cross section of the suction head of the vacuum accessory is smaller than that of the vacuum chamber of the vacuum cup.

6. The vacuum sucker for workpiece having through holes as claimed in claim 1, wherein the passage comprises a first passage which is axially defined in the vacuum accessory and penetrates from the assembling section to the suction head of the vacuum accessory and at least one passage which is defined in the outer surface of the suction head of the vacuum accessory and extends towards a close end of the first passage, the first passage is in communication with the at least one passage, one end of the first passage towards the assembling section of the vacuum accessory is an open end, and the other end of the first passage towards the suction head is the close end.

7. The vacuum sucker for workpiece having through holes as claimed in claim 6, wherein the passage of the suction head of the vacuum accessory is radially arranged.
